(19) United States
(12) Patent Application Publication
(10) Pub. No.: US 2013/0328677 A1
(43) Pub. Date: Dec. 12, 2013

(54) Home Monitoring/Security System With Dual Communication Options

(71) Applicant: Reliance Controls Corporation, Racine, WI (US)

(72) Inventor: Neil A. Czarnecki, Mt. Pleasant, WI (US)

(73) Assignee: Reliance Controls Corporation, Racine, WI (US)

(21) Appl. No.: 13/967,539

(22) Filed: Aug. 15, 2013

(51) Int. Cl. G08B 1/08

(52) U.S. Cl. CPC G08B 1/08
USPC 340/539.1

(57) ABSTRACT

A building monitoring system having dual communication options is disclosed. The controller is configured to communicate via a pair of communication networks, According to one embodiment of the invention, the controller is connected to a Public Switched Telephone Network (PSTN) and to a Global System for Mobile Communications (GSM) network. The controller further includes a gateway to selectively connect the PSTN to the GSM network. The controller may monitor the status of the PSTN line. If the PSTN line is operational, the gateway connects the PSTN jack from the telephone to the PSTN jack for the telephone line. If the PSTN line is not operational, the PSTN jack from the telephone is connected to a converter which is, in turn, connected to a cellular radio. The converter is configured to convert the analog signals for the PSTN to digital signals for transmission via the GSM network and vice versa.

### BACKGROUND OF THE INVENTION

The subject matter disclosed herein relates to a system for monitoring sensors both for detecting environmental conditions as well as building security. More specifically, a system configured to provide monitoring and security for a building with notification via a standard telephone line or via a cellular network is disclosed.

As is known to those skilled in the art, building monitoring and/or security systems are configured to receive data from sensors at a central controller. The sensors are often located remotely from the central controller, for example, at a window or door to detect whether the window or door is open or closed. The sensors may be connected to the central controller via either a wired connection or a wireless connection to provide a signal corresponding to the monitored condition. The central controller receives the signal and determines a response based, for example, on whether the central controller is activated or deactivated. If a person is present in the building, then there may be no response necessary to a door opening however, if no one is present in the building the controller may generate an alarm when a door opens. The controller may further be configured to delay generation of an alarm for a predetermined period to allow an authorized person to deactivate the controller upon entering the building.

As is also known to those skilled in the art, building monitoring and/or security systems are configured to report events, for example, to a remote monitoring facility so that action may be taken when an event occurs. Optionally, the system may be configured to contact one or more phone numbers, for example, belonging to the building owner to alert the owner of the event. However, communications networks are subject to failure due to, for example, severe weather or equipment failure. Thus, the system may also provide the option to communicate via multiple communication networks to increase reliability of reporting the event.

However, there are times when the building may be occupied and the system is disabled when an event occurs. For example, the owner is present and disables the system to prevent a motion detector from continuously reporting the presence of an individual in the building. While the system is disabled, a storm knocks over a tree nearby disrupting the electrical service to the building. The tree may also disable phone service via the public switched telephone network (PSTN). Consequently, the system does not report an event and the individual in the building may be unable to communicate the event.

Thus, it would be desirable to provide a building monitoring and/or security system that permits an individual within the building to communicate via the multiple communication networks included within the system.

### BRIEF DESCRIPTION OF THE INVENTION

The subject matter disclosed herein describes a building monitoring and security system having dual communication options. The monitoring system includes a central controller configured to receive data from sensors located about the building. The sensors may monitor an environmental condition within the building such as the temperature or a water level in the basement of the building. Optionally, the sensors may detect a security condition such as motion, glass breakage, or a door or window opening. The central controller is also configured to communicate via a pair of communication networks. One of the two networks is configured as a primary network and the other as a secondary network by which the controller may communicate if the primary network fails. According to one embodiment of the invention, the central controller is connected to a Public Switched Telephone Network (PSTN) and to a Global System for Mobile Communications (GSM) network.

For ease of installation, the central controller includes a jack compatible with the PSTN, configured to receive, for example, a RJ14 connector. A phone line, terminated at each end with a RJ14 connector, is plugged into the central controller at one end and a wall-mounted jack at the other end. For further convenience, the central controller also includes an additional jack compatible with the PSTN. Because many buildings include a limited number of PSTN jacks and typically include only one in a room, installation of the central controller would require either a hardwired connection to the POTS, a dedicated RJ14 jack, or would use one of the RJ14 jacks originally intended for connection to a telephone. The additional PSTN jack in the central controller receives a phone line plugged in between a telephone and the central controller. The central controller selectively connects the two PSTN jacks internally allowing the telephone to connect to the PSTN jack in the wall.

The central controller further includes a gateway to selectively connect the PSTN jack from the telephone to the GSM. network. The controller monitors the status of the PSTN line. If the PSTN line is connected to the controller and operational, the gateway connects the PSTN jack from the telephone to the PSTN jack for the telephone line. If the PSTN line is disconnected or determined to he not operational, the PSTN jack from the telephone is connected to a converter which is, in turn, connected to a cellular radio. The converter is configured to convert the analog signals for the PSTN to digital signals for transmission via the GSM network and vice versa.

According to one embodiment of the invention, a system to monitor a plurality of conditions in a building includes a plurality of sensors, a pair of jacks for a public switched telephone network (PSTN), a cellular radio transceiver configured to communicate with a wireless network, a memory device configured to store a series of instructions to control the system and to store multiple phone numbers, and a controller. Each sensor may be in communication with the controller via either a wired or a wireless connection, configured to monitor one of the conditions in the building, and configured to generate a signal corresponding to a state of the monitored condition. A first jack is configured to receive a first connector for the PSTN to establish communication with a PSTN telephone. A second jack is configured to receive a second connecter for the PSTN to establish connection with the PSTN. The controller is in communication with each of the sensors to receive the signal generated by the sensor and is operatively connected to the memory device. The controller is selectively in communication with the PSTN via the second jack and with the wireless network via the cellular radio transceiver to dial at least one of the phone numbers responsive to the signals received from the sensor. The controller provides an indication of the status of the signal to the dialed phone number via one of the PSTN and the wireless network. The system also includes a pass-through configured to selectively connect either the first jack or the controller to the second jack and a gateway configured to selectively connect the first jack to either the cellular radio or the second jack. The gateway is also configured to convert an analog signal compatible with the PSTN received from the first jack to a digital signal compatible with the wireless network for transmission via the cellular radio and to convert the digital signal received from the cellular radio to the analog signal for transmission via the first jack.

According to another aspect of the invention, the controller is configured to monitor the condition of the PSTN via the second jack. When the PSTN is operational, the gateway connects the first jack to the second jack and, when the PSTN is not operational, the gateway connects the first jack to the cellular radio. The wireless network may be the GSM network.

According to another embodiment of the invention, a system to monitor a plurality of conditions in a building includes a plurality of sensors, a jack configured to receive a connector for a PSTN to establish communication with a PSTN telephone, a plurality of terminals configured to establish a connection with the PSTN, a cellular radio transceiver configured to communicate with a wireless network, a memory device configured to store a series of instructions to control the system and to store multiple phone numbers, and a controller. Each sensor is configured to monitor one of the plurality of conditions and to generate a signal corresponding to a state of the monitored condition, The controller is in communication with each of the sensors via a wired or wireless connection to receive the signal generated by the sensor and is operatively connected to the memory device. The controller is selectively in communication with the PSTN via the terminals and with the wireless network via the cellular radio transceiver to dial at least one of the phone numbers responsive to the signals received from the sensor. The controller provides an indication of the status of the signal to the dialed phone number via either the PSTN or the wireless network. The system also includes a pass-through configured to selectively connect the jack or the controller to the PSTN and a gateway configured to selectively connect the jack to the cellular radio or the PSTN. The gateway is also configured to convert an analog signal compatible with the PSTN received from the jack to a digital signal compatible with the wireless network for transmission via the cellular radio and to convert the digital signal received from the cellular radio to the analog signal for transmission via the jack.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and riot of limitation. Many changes and modifications may be made within the scope of the present invention without departing from the spirit thereof, and the invention includes all such modifications.

### BRIEF DESCRIPTION OF THE DRAWING(S)

Various exemplary embodiments of the subject matter disclosed herein are illustrated in the accompanying drawings in which like reference numerals represent like parts throughout, and in which:

FIG. 1 is a block diagram representation of a monitoring system according to one embodiment of the present invention;

FIG. 2 is a block diagram representation of a controller from the monitoring system of FIG. 1; and

FIG. 3 is a flow chart illustrating the steps in reporting an event with the monitoring system of FIG. 1.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

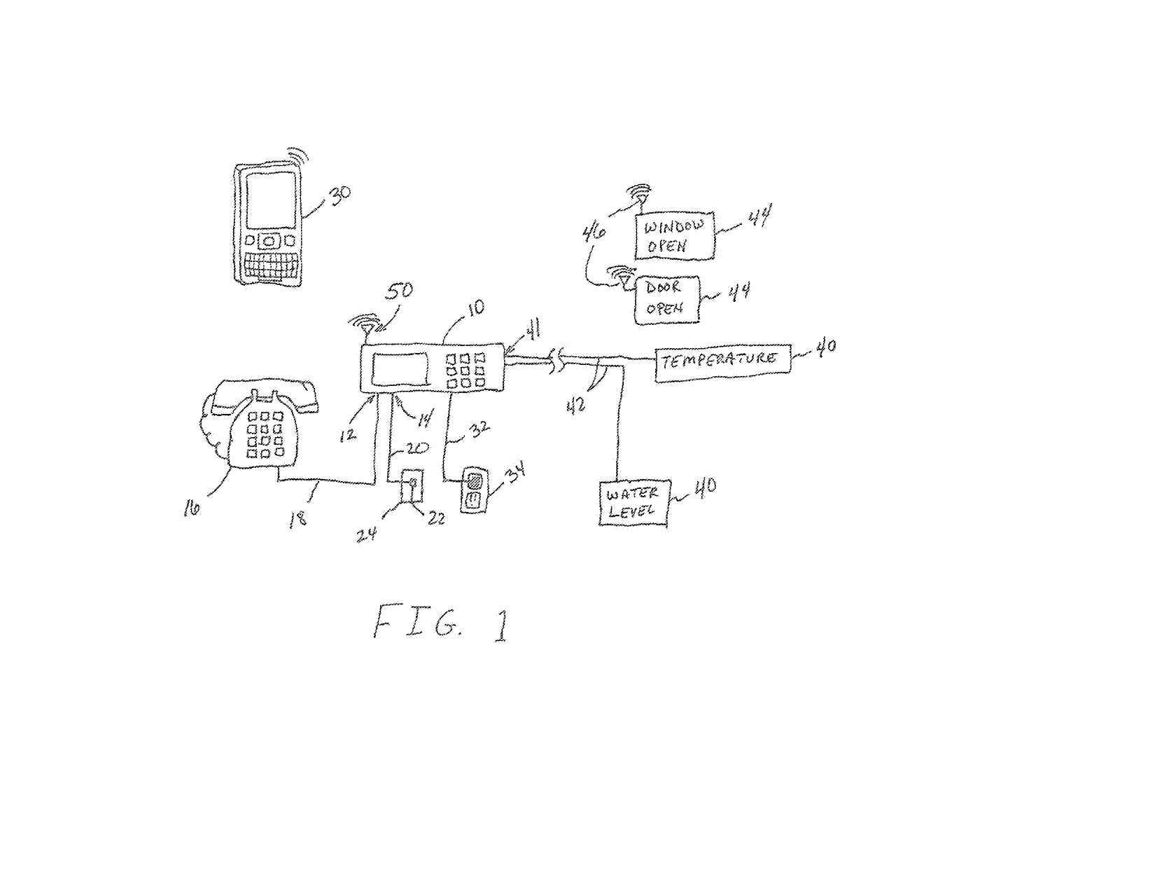

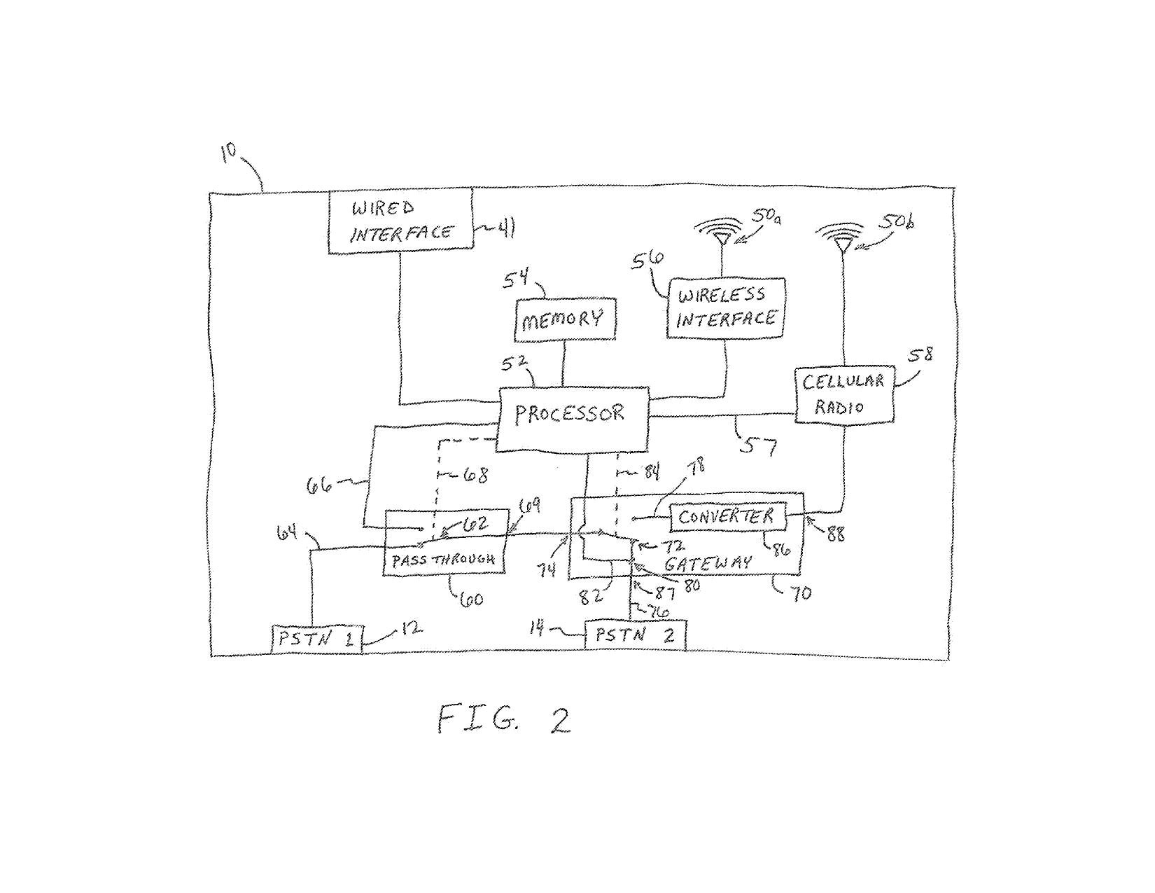

Turning initially to FIG. 1, a building monitoring and/or security system includes a controller 10 configured to receive data from sensors 40, 44 distributed about the building. The sensors may he wired sensors 40, which are in communication with the controller 10 via a suitable electrical conductor 42, or wireless sensors 44, which are in communication with the controller 10 via an antenna 46 and a wireless interface. The sensors 40, 44 may be configured to monitor environmental conditions within the building, such as a smoke, carbon monoxide, temperature, water level, or power outage. Optionally, the sensors 40, 44 may be configured to monitor security conditions such as motion within the building, glass breakage sensor, or opening of a window or door. Each of the wired sensors 40 transmits a signal corresponding to the monitored condition via the conductor 42 to a wired interface 41 (see also FIG. 2) within the controller 10. Each of the wireless sensors 44 transmits a signal corresponding to the monitored condition via its antenna 46 to an antenna 50 and a wireless interface 56 within the controller 10.

According to the illustrated embodiment, the controller 10 may communicate via the PSTN or a GSM network. The controller 10 includes a first PSTN jack 12, configured to connect to a telephone 16 via a telephone line 18, and a second PSTN jack 14 configured to connect to the PSTN. The second PSTN jack 14 may be connected to a PSTN jack 22 in a wall-mounted PSTN connection 24 via a second telephone line 20. Optionally, the controller 10 may include a set of terminals at which one end of a telephone line is terminated. The line may be run within the walls of the building back to a terminal block located at the point in the building at which the PSTN enters, and the second end of the line may be terminated at the entry terminal block. Referring also to FIG. 2, the controller 10 may communicate via a cellular radio 58 to a wireless device 30 such as a cellular phone, tablet computer, or other wireless device similarly configured to communicate via the GSM network. As illustrated, the controller 10 may receive power via a cord 32 plugged into an outlet 34. Optionally, the controller 10 may be wired directly to a junction box located, for example, behind a wall mount for the controller 10.

Referring next to FIG. 2, the controller 10 includes a memory 54 configured to store a series of instructions to control the system and to store a plurality of phone numbers. It is contemplated that the memory 54 may be a single device, multiple devices, volatile memory, non-volatile memory, or a combination thereof without deviating from the scope of the invention. A processor 52 is in communication with the memory 54 and configured to execute the stored instructions. It is contemplated that the processor 52 may be a single device or multiple devices and may be implemented in part or in whole in a logic circuit, a microprocessor, a field programmable gate array, an application specific integrated circuit, or a combination thereof. The processor 52 is in communication with a wired interface 41 and a wireless interface 56 to receive signals from sensors 40, 44. The processor 52 is also in communication with a cellular radio 58 to communicate via a wireless network, such as the GSM network. The controller 10 includes at least one antenna 50 for wireless communications. As illustrated, the controller 10 may include a first antenna 50a configured to communicate with the wireless sensors 44 and a second antenna 50b configured to communicate with the wireless network.

The controller 10 further includes a pass-through 60 configured to allow a telephone 16 to be connected to the PSTN via the controller 10. If the controller 10 is installed during construction of the building, it may be desirable to run a telephone line between a terminal block at the entry point for the PSTN service to the controller. The controller 10 may include a set of terminals to receive the telephone line. However, if the controller 10 is installed after construction of the building, installation may he simplified by connecting the controller 10 to a PSTN jack 22 in a wall-mounted PSTN connection 24. Because some buildings, in particular some residential buildings, include a limited number of wall-mounted PSTN connections 24, the pass-through 60 allows a telephone 16 to be connected to the same wall-mounted PSTN connection 24 as the controller 10. The pass-through 60 includes a switch 62 to selectively connect either the first PSTN jack 12 or the processor 66 to the output 69 of the pass-through 60. The controller 10 only communicates via the PSTN when an event occurs; therefore, the switch 62 is configured to normally connect the first PSTN jack 12 to the output 69 of the pass-through 60. When an event occurs or the controller needs to communicate for any other reason, a control signal 68 from the processor 68 causes the switch 62 to disconnect the first PSTN jack 12 and connect the processor 52 to the output 69 of the pass-through 60.

The controller 10 also includes a gateway 70 which routes the output 69 of the pass-through 60 to one of the two communication networks. A sensor 80 monitors the status of the PSTN and transmits a signal 82 back to the processor 52 corresponding to the monitored status. If the PSTN is connected to the controller 10 and operational, a switch 72 in the gateway 70 routes the output 69 of the pass-through 60 to the first output 87 of the gateway 70 which is, in turn, connected to the second PSTN jack 14 such that the telephone 16 may communicate via the PSTN. If, however, the processor 52 detects a failure in the PSTN, the processor 52 generates a control signal 84 which causes the switch 72 to route the output 69 of the pass-through 60 to a converter 86. Because the PSTN transmits data via analog signals and the GSM transmits data via digital signals, the converter 86 converts incoming signals in one form from either the telephone or the cellular radio to the other form for transmission to the other device. The converter 86 is connected to the second output 88 of the gateway, which is, in turn, connected to the cellular radio 58.

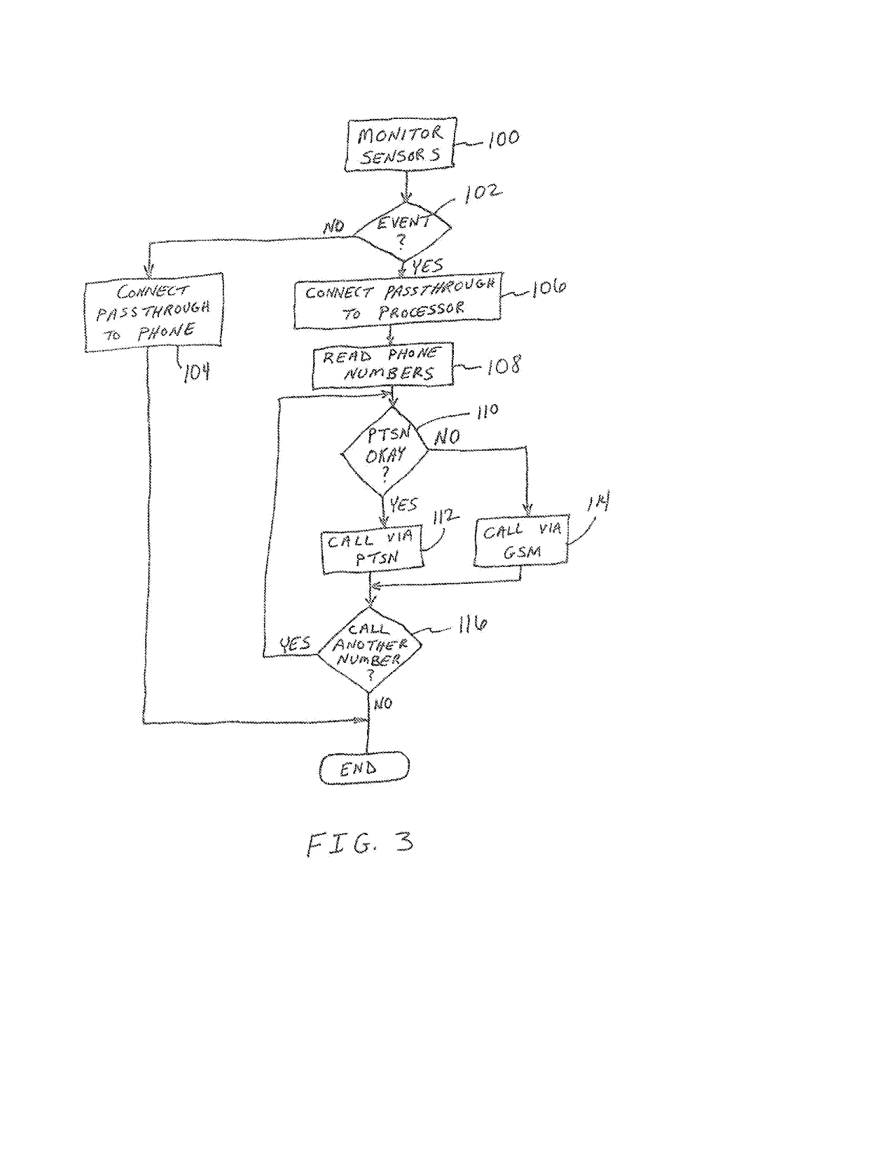

In operation, the controller 10 monitors signals from the sensors and is configured to provide notification of an event via one of the communication networks. Referring also to FIG. 3, the controller 10 monitors the sensors 40, 44 as shown in step 100. At step 102, the controller determines whether an event occurred. The conditions to determine whether an event occurred may be configured and stored in memory 54 in the controller. For example, events such as security events may require the controller 10 be activated to monitor for the event. The controller 10 may identify a security event occurring if it detects a door opening when activated (e.g., when nobody is supposed to be present in the building) versus if it detects a door opening when deactivated (e.g., when people are present in the building). Certain events may be continuously monitored, for example, smoke detectors or temperature sensors that, for example, detect too low of a temperature within the building. It is further contemplated that the controller 10 may include a configurable time delay, requiring the sensor 40, 44 to generate the signal corresponding to the event for a preset time prior to generating an event in order to avoid false alarms. If no event is detected, the controller 10 generates the control signal 68 which connects the output 69 of the pass-through 60 to the first PSTN jack 12, as shown in step 104, thereby allowing the telephone 16 connected to the controller 10 to communicate via one of the two connected networks, If an event is detected, the controller 10 generates the control signal 68 which connects the output 69 of the pass-through 60 to the processor 52, as shown in step 106, such that the controller 10 may report the event via one of the two connected networks.

The controller 10 is also configurable to report the event to one or more phone numbers. During setup of the controller 10, a list of phone numbers to be dialed is stored in memory 54. It is contemplated that events triggered by different sensors 40, 44 may be configured to contact different phone numbers. Further, each event may be configured to contact multiple phone numbers. Alternately, certain phone numbers may be associated with all events. At step 108, the list of phone numbers associated with a specific event is read from memory 54. At step 110, the controller 10 checks if the PTSN is available for transmission. The controller 110 may at periodic intervals check the status of the PSTN. for example, by monitoring the DC voltage potential across the tip and ring wires. When the PTSN is present, 48 VDC is present if the phone is “on-hook” and 6-8 VDC is present if the phone is “off-hook”. Other voltage levels and/or the absence of a DC voltage may indicate the PTSN has failed or is not connected. If the controller 10 determines that the PTSN is available for transmission, it generates the control signal 84 for the switch 72 in the gateway to connect the input 74 of the gateway 70 to the first output 87 of the gateway, thereby connecting the output 69 of the pass-through 60 to the second PSTN jack 14. As shown in step 112, a first phone number from the list is then called via the PSTN. If, however, the controller 10 determines that the PTSN is not available for transmission, it generates the control signal 84 for the switch 72 in the gateway to connect the input 74 of the gateway 70 to the converter 86 in the gateway, which is, in turn connected to the cellular radio 58 via the second output 88 of the gateway 70. As shown in step 114, the first phone number from the list is then called via the GSM. At step 116, the controller checks whether additional phone numbers need to be contacted based on the event that occurred, If additional phone numbers need to be contacted, then steps 110-114 are repeated. If all of the phone numbers configured to be contacted based on the event have been called, then the controller is done reporting that event.

It should be understood that the invention is not limited in its application to the details, of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

I claim:

1. A system to monitor a plurality of conditions in a building, the system comprising:
a plurality of sensors, each sensor configured to monitor one of the plurality of conditions and to generate a signal corresponding to a state of the monitored condition;
a first jack configured to receive a first connector for a public switched telephone network (PSTN) to establish communication with a PSTN telephone;
a second jack configured to receive a second connecter for the PSTN to establish connection with the PSTN;
a cellular radio transceiver configured to communicate with a wireless network;
a memory device configured to store a series of instructions to control the system and to store a plurality of phone numbers;
a controller wherein the controller is in communication with each of the sensors to receive the signal generated by the sensor, the controller is operatively connected to the memory device, the controller is selectively in communication with the PSTN via the second jack and the wireless network via the cellular radio transceiver to dial at least one of the plurality of phone numbers responsive to the signals received from the sensors, and the controller provides an indication of the status of the signals to the phone number dialed via one of the PSTN and the wireless network;
a pass-through configured to selectively connect one of the first jack and the controller to the second jack; and
a gateway configured to selectively connect the first jack to one of the cellular radio and the second jack and configured to convert an analog signal compatible with the PSTN received from the first jack to a digital signal compatible with the wireless network for transmission via the cellular radio and to convert the digital signal received from the cellular radio to the analog signal for transmission via the first jack.

2. The system of claim 1 wherein the controller is configured to monitor the PSTN via the second jack and wherein the gateway connects the first jack to the second jack when the PSTN is operational and the gateway connects the first jack to the cellular radio when the PSTN is not operational.

3. The system of claim 1 wherein each of the sensors is in communication with the controller via one of a wired and a wireless connection.

4. The system of claim 1 wherein the wireless network is a Global System for Mobile Communications (GSM) network.

5. A system to monitor a plurality of conditions in a building, the system comprising:
a plurality of sensors, each sensor configured to monitor one of the plurality of conditions and to generate a signal corresponding to a state of the monitored condition;
a jack configured to receive a connector for a public switched telephone network (PSTN) to establish communication with a PSTN telephone;
a plurality of terminals configured to establish a connection with the PSTN;
a cellular radio transceiver configured to communicate with a wireless network;
a memory device configured to store a series of instructions to control the system and to store a plurality of phone numbers;
a controller wherein the controller is in communication with each of the sensors to receive the signal generated by the sensor, the controller is operatively connected to the memory device, the controller is selectively in communication with the PSTN via the plurality of terminals and the wireless network via the cellular radio transceiver to dial at least one of the plurality of phone numbers responsive to the signals received from the sensors, and the controller provides an indication of the status of the signals to the dialed phone number via one of the PSTN and the wireless network;
a pass-through configured to selectively connect one of the jack and the controller to the PSTN; and
a gateway configured to selectively connect the jack to one of the cellular radio and the PSTN and configured to convert an analog signal compatible with the PSTN received from the jack to a digital signal compatible with the wireless network for transmission via the cellular radio and to convert the digital signal received from the cellular radio to the analog signal for transmission via the jack.

6. The system of claim 5 wherein the controller is configured to monitor the PSTN via the terminals and wherein the gateway connects the jack to the PSTN when the PSTN is operational and the gateway connects the jack to the cellular radio when the PSTN has failed.

7. The system of claim 5 wherein each of the sensors is in communication with the controller via one of a wired and a wireless connection.

8. The system of claim 5 wherein the wireless network is a Global System for Mobile Communications (GSM) network.
